(19) United States
(12) Patent Application Publication
(10) Pub. No.: US 2007/0295110 A1
(43) Pub. Date: Dec. 27, 2007

(54) Load cell

(76) Inventors: Keith Hochhalter, Inverness, IL (US); Joseph G. Dumas, Corcoran, MN (US); Brett C. Holker, Monticello, MN (US); Drew O. Taylor, Otsego, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/430,528

(22) Filed: May 9, 2006

(51) Int. Cl. G01L 3/00

(52) U.S. Cl. 73/862.332

(57) ABSTRACT

A load cell for monitoring the axial load on a linear actuator. In one embodiment, the load cell is part of a bearing assembly positioned between a rotation bearing and a bearing housing.

### BACKGROUND OF THE INVENTION

1. Field of the Invention

The present invention relates generally to a load cell and more particularly to a load cell or device for measuring the axial load on a machine or machine component through a rotation bearing. The invention has particular applicability for use in a bearing assembly and for use in linear actuators and more specifically, screw-type linear actuators. Accordingly, the invention also relates to a linear actuator and a bearing assembly incorporating such load cell.

2. Description of the Prior Art

Various machines and machine components currently exist in which the ability to measure monitor axial forces acting on such machines or components is beneficial and desired. One specific example, among others, includes a variety of linear actuators such as those used in resistance welding to linearly move a welding head into a welding position to produce a desired resistance. The real time monitoring of forces exerted by the actuator or the maintenance of such forces within a predefined range would be highly beneficial and would enhance the efficient use of such actuator. Accordingly, there is a need in the art for a load cell or other device which can be used to measure or monitor the axial load on a machine or component such as a linear actuator.

### SUMMARY OF THE INVENTION

The present invention relates to a load cell or force measuring device for measuring the axial force or load on a machine or a machine component. Although the device of the present invention has a wide range of potential applications, it has particular applicability for use in measuring or monitoring the force exerted by a linear actuator on a workpiece. More specifically, the present invention is directed to a load cell or force measuring device for measuring the axial force exerted by a linear actuator in a resistance welding application. Still more specifically, the load cell of the present invention measures or monitors the force exerted in a screw-type linear actuator through its rotational support bearing. Accordingly, the present invention is directed to such load cell and to a linear actuator and a bearing assembly incorporating the load cell.

In the preferred embodiment which is described with respect to a screw-type linear actuator, the load cell or force measuring device is positioned between the rotational support bearing and the bearing housing and includes a stabilizing sleeve portion and a force measuring cell portion. The force measuring cell portion includes a force receiving surface engageable with a portion of the bearing and an opposite force transmission surface engageable with a portion of the bearing housing. A flexing or force measuring area in the form of a flexing web is positioned between the force receiving and force transmission surfaces. A strain gauge is mounted in the area of the flexing web to measure the strain in the flexing web and thus, through signal amplification and calibration techniques, the level of force exerted by the bearing on the force measurement cell.

In the preferred embodiment, both the strain gauge connection board and the amplification electronics are integrated within the actuator itself. This eliminates long cables and strain gauge wire and results in improved signal-to-noise ratio and a more robust system.

Accordingly, an object of the present invention is to provide a load cell or force measuring device for measuring axial forces exerted upon a machine or machine component.

Another object of the present invention is to provide a load cell or force measuring device for a linear actuator.

A still further object of the present invention is to provide a load cell or force measuring device for measuring axial forces exerted through a rotational support bearing.

A still further object is to provide a linear actuator and/or a bearing assembly with such a load cell incorporated therein.

A still further object of the present invention is to provide a linear actuator with an axial force load cell in which the load cell measuring and amplification electronics are integrated into the actuator itself.

These and other objects of the present invention will become apparent with reference to the drawings, the description of the preferred embodiment and the appended claims.

### DESCRIPTION OF THE DRAWINGS

FIG. 1 is an isometric, exploded view showing the load cell of the present invention together with its associated components of a screw-type linear actuator.

FIG. 2 is a view, partially in section, of the load cell of the present invention installed within a screw-type linear actuator as viewed along a section line through the longitudinal axis.

FIG. 3 is an isometric view of a load cell or force measuring device in accordance with the present invention as viewed from its proximal end.

FIG. 4 is a further isometric view of the load cell or force measuring device in accordance with the present invention as viewed from its distal end.

FIG. 5 is an elevational plan view of the force transmitting or proximal end of the load cell in accordance with the present invention.

FIG. 6 is an elevational side view of the load cell in accordance with the present invention.

FIG. 7 is a view, partially in section, as viewed along the section line 7-7 of FIG. 5.

FIG. 8 is a fragmentary, enlarged view showing the flexing web or strain measuring portion of the load cell in accordance with the present invention.

FIG. 9 is an isometric view of a linear actuator of the type to which the load cell of the present invention has particular application.

### DESCRIPTION OF THE PREFERRED EMBODIMENT

The present invention is directed to a load cell or force measuring device for measuring or monitoring the axial load or force exerted by a machine or machine component on a work piece. Although the present invention has potential applicability for use with a variety of machines or machine components, it has particular applicability to a linear actuator such as a screw-type linear actuator of the type shown in U.S. Patent Application Publication No. US-2005-0253469-A1 and U.S. Pat. No. 6,756,707, incorporated herein by reference. The invention is also applicable to a through hole type actuator as shown in the preferred embodiment in which the screw shaft or rotating extension thereof extends through the load cell or to a closed end actuator in which the screw shaft does not extend through the load cell.

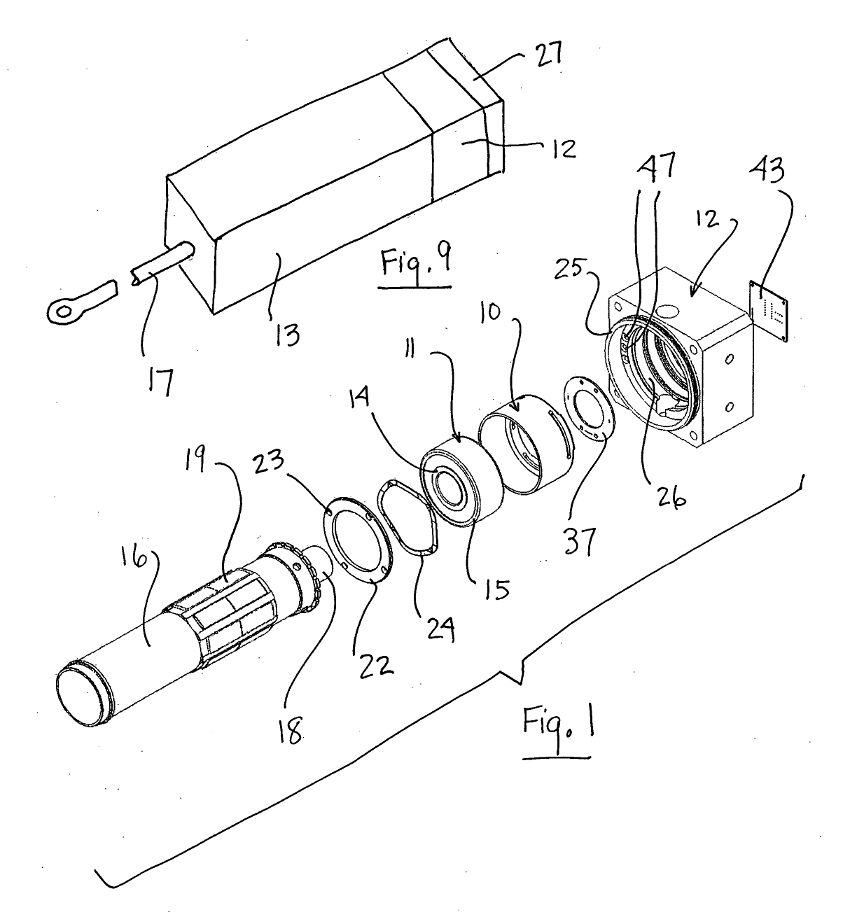

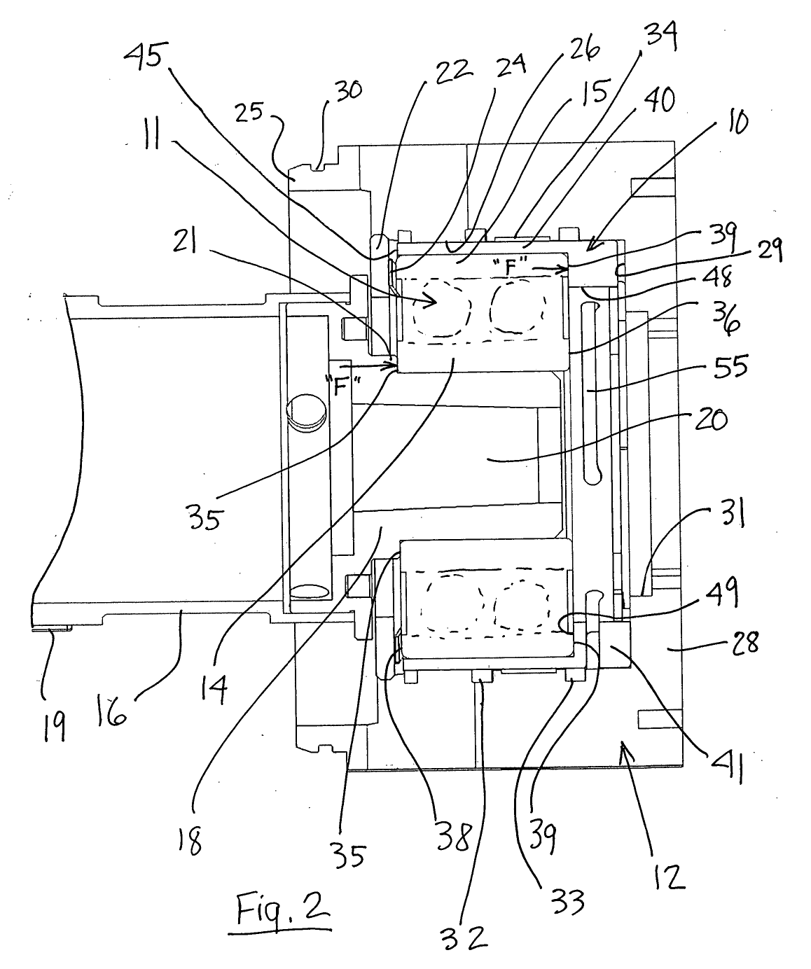

Accordingly, the preferred embodiment of the present invention will be described with respect to a screw-type linear actuator of the type shown in U.S. Patent Application Publication No. US-2005-0253469-A1. The subject matter of this published application is incorporated herein by reference and made a part hereof. An isometric view of such an actuator is shown in FIG. 9 in which the actuator includes a main body 13, a rearward or proximal end in the form of the end block or bearing housing 12 and a forward or force exerting distal end through which a linearly moveable thrust rod 17 extends. The proximal end may include an end cap or encoder housing such as that shown by reference character 27. As shown in FIGS. 1 and 2, the internal components of the actuator include a motor comprising a hollow rotor 16 rotated by a stator (not shown), a bearing 11 supported within the bearing housing 12 and a screw shaft rotatable with the rotor 16. In the preferred embodiment, the screw shaft is mounted within the screw shaft interface 20 of FIG. 2. During operation, rotation of the rotor 16 and thus the screw shaft and screw shaft interface 20 causes corresponding movement of a thrust tube and thus the thrust rod 17 in a manner known in the art.

In describing the load cell of the present invention, the terms “distal” and “proximal” will be used to define the various surfaces or other portions of the load cell and other components. As used herein, the term “distal” shall define the surface or portion which is closest to the force exerting end of the actuator or machine, while the term “proximal” shall define the surface or portion which is furthest from the force exerting end of the actuator or machine.

In describing the load cell 10, initial reference is made to FIGS. 1 and 2 showing the load cell 10 in its relationship with associated component parts of a screw-type linear actuator of the type referred to above. As shown best in FIG. 2, the load cell 10 is designed for positioning between the bearing 11 and the bearing housing 12. In the preferred embodiment, the bearing 11 is a dual row rotational support bearing having an inner race 14, an outer race 15 and two rows of bearing elements between them. The inner race 14 includes an inner cylindrical surface, a distal end 35 and a proximal end 36. The outer race 15 includes an outer cylindrical surface, a distal end 38 and a proximal end 39. When installed as shown in FIG. 2, the distal end of the inner race is engaged by a portion of the rotor 16 to receive a force from the rotor, while the proximal end 39 of the outer race 15 engages a portion of the load cell 10. With this arrangement, axial forces acting on the rotor 16 are transferred through the bearing 11 to the load cell 10. Various types and styles of bearings may be utilized with the load cell of the present invention. However, because the bearing in the preferred embodiment of the present invention is used to transmit an axial force on the inner race to the outer race, the bearing should preferably have sufficient strength and stability to accommodate this force transmission without damage to the bearing.

The bearing 11 is retained within the bearing housing 12 by a disc-shaped, externally threaded retainer ring 22. As shown best in FIG. 2, the retainer ring 22 is threadedly received by an inner surface portion of the bearing housing 12. The retainer ring 22 includes a plurality of holes 23 (FIG. 1) to receive a spanner wrench or other tool to assist in threadedly advancing the ring 22 into the housing 12. In the preferred embodiment, a wave washer 24 is positioned between the retaining ring 22 and a distal end portion of the bearing 11. Specifically, as shown in FIG. 2, the wave washer 24 is sandwiched between and contacts the proximal side of the ring 22 and the distal end 38 of the outer race 15. When assembled, the washer 24 is preloaded by controlling the threaded advancement of the retaining ring into the housing 12. In its preloaded condition, the washer 24 provides a predetermined force or load against the bearing outer race 15.

With continuing reference to FIGS. 1 and 2, the screw-type linear actuator of the preferred embodiment includes a rotor 16 which, in the preferred embodiment, is driven by a hollow core motor (not shown). The rotor 16 includes a rotor hub 18 which rotates with the rotor 16. The rotor elements 16 and 18 may be two separate parts which are joined together for rotation or simply constructed as a single part. As shown best in FIG. 1, the rotor 16 includes a plurality of magnets 19 on its outer surface as part of a hollow core motor of the type described in the above-identified published patent application. As shown in FIG. 2, the rotor hub 18 is connected to a screw shaft 20 near its proximal end via a press fit or other connection mechanism and is also press fit or otherwise joined to the inner race 14 of the bearing 11. The rotor or rotor hub 18 includes a shoulder portion 21 (FIG. 2) which engages the distal end 35 of the inner race 14. This shoulder 21 functions to transmit force “F” from the rotor 16 to the bearing 11.

The bearing housing 12 is comprised of a block member having a distal end 25, a cylindrical inner surface 26 and a portion 28 at its proximal end. The portion 28 extends radially inwardly from the cylindrical surface 26 and includes an inner annular surface 29 designed for engagement with a proximal end of the load cell 10. The housing 12 includes a central opening or through hole 31 at its proximal end. This opening 31 is sufficiently large to permit the screw shaft 20 or an extension thereof to extend through the housing 12. In the preferred embodiment, the distal end 25 includes a recess 30 to receive an O-ring for connection with the main body 13 (FIG. 9) of the linear actuator. The inner cylindrical surface 26 includes a pair of O-ring grooves 32 and 33 to receive corresponding O-rings. The O-rings in the grooves 32 and 33 provide seal means for a lubrication channel 34. As will be described in greater detail below, the O-rings within the grooves 32 and 33 engage an outer surface portion of the load cell 10 and, together with the lubricating channel 34, facilitate limited axial movement of the load cell 10 within the bearing housing 12.

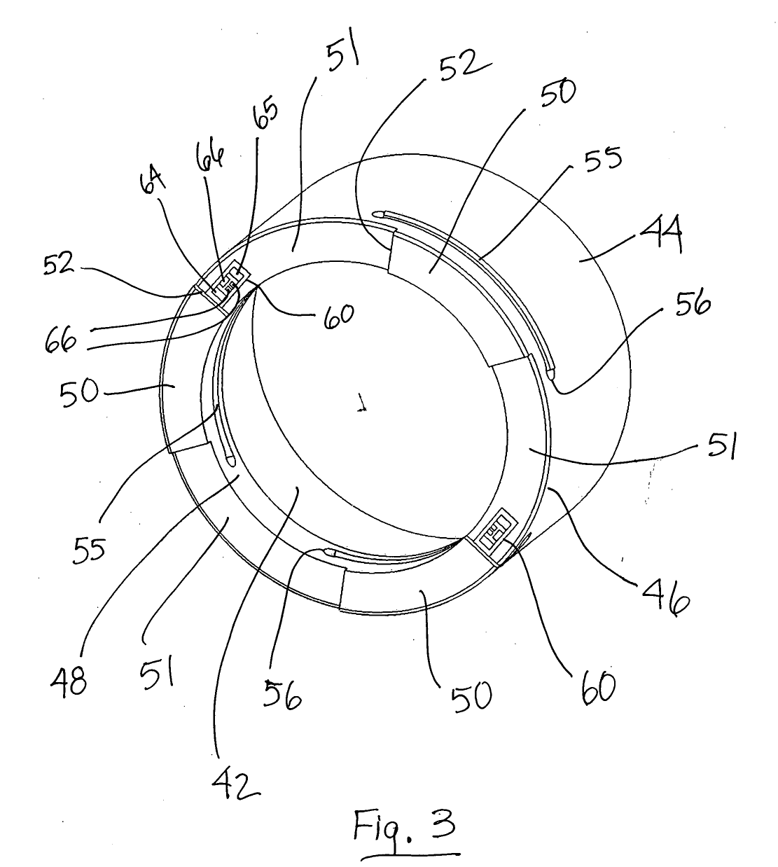

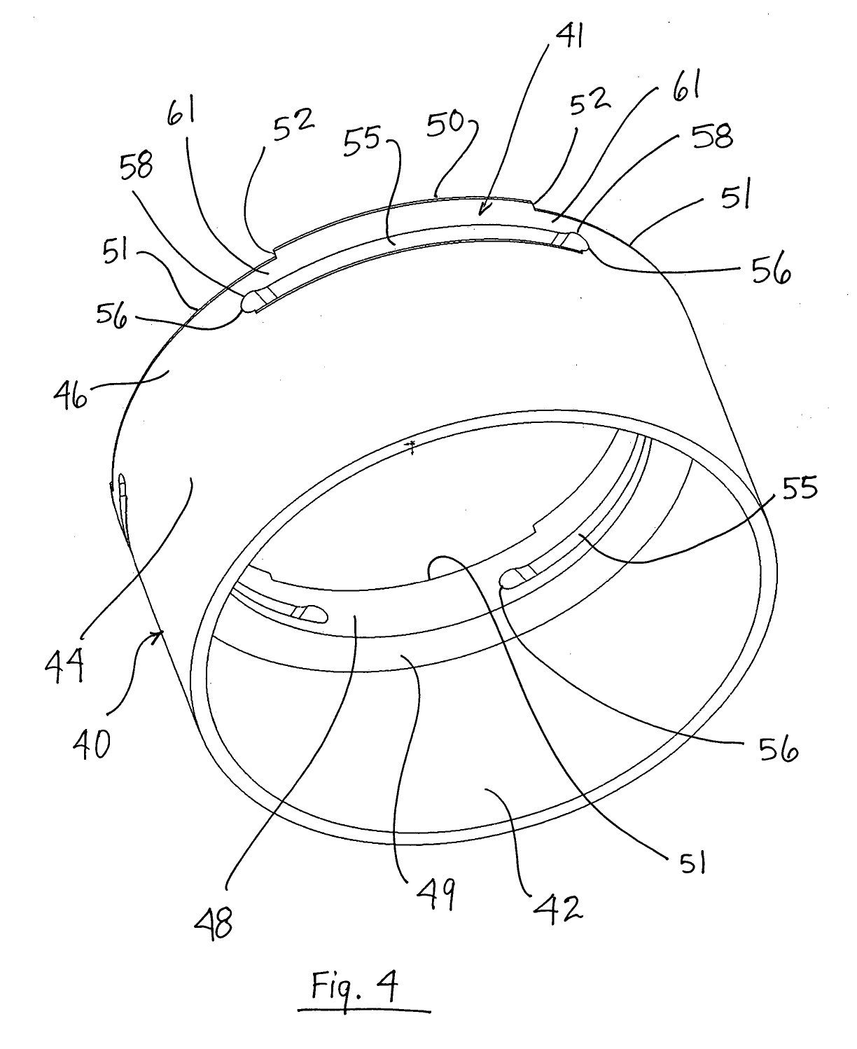

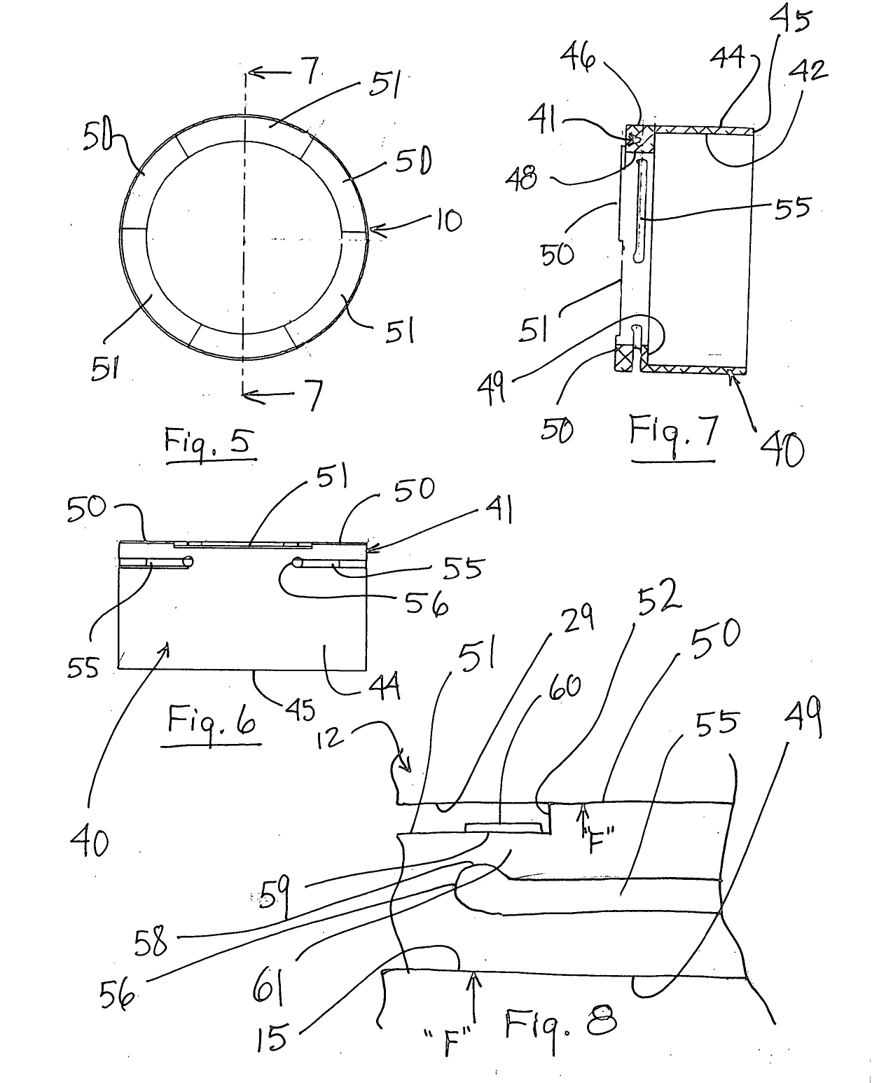

The load cell 10 is described best with general reference to FIGS. 1 and 2 showing the load cell 10 in combination with associated components of a linear screw actuator, and with more specific reference to FIGS. 3, 4, 5, 6 and 7 showing various views of the load cell 10 by itself. In general, the load cell 10 of the preferred embodiment includes a stabilizing sleeve portion 40 and a force measuring cup or cell portion 41. When assembled as part of the bearing assembly of the present invention, the stabilizing sleeve portion 40 is positioned between the outer cylindrical surface of the outer bearing race 15 and the inner cylindrical surface 26 of the bearing housing 12. The sleeve portion 40 is generally cylindrical having an inner cylindrical surface 42 and an outer cylindrical surface 44. When assembled within the actuator, the sleeve 40 is positioned between the bearing 11 and the bearing housing 12, with the inner cylindrical surface 42 of the sleeve 40 adjacent to the outer cylindrical surface of the outer bearing race 15 and the outer cylindrical surface 44 of the sleeve 40 adjacent to the inner cylindrical surface 26 of the housing 12. In this position, the sleeve portion 40 extends substantially the entire axial length of the bearing 11 and terminates at a free distal end 45.

The proximal end of the sleeve portion 40 is integrally formed with the force measuring cell portion 41 as shown best in FIGS. 2, 3 and 4. During use, the sleeve portion 40 functions primarily to stabilize the force measuring cell 41 and to minimize twisting of the bearing 11 and/or load measuring cell portion 41 and distortion of forces exerted on the cell 41 by the bearing 11. When assembled, lubrication is present within the lubrication channel 34 between the surface 26 and the outer surface 44 of the sleeve 40 to facilitate limited axial movement of the sleeve 40, and thus the entire load cell 10, relative to the housing 12. The lubrication is captured within the channel 34 by O-rings within the O-ring grooves 32 and 33.

The force measuring cell 41 is a generally cylindrical structure having an outer cylindrical wall or surface 46 continuous with the outer cylindrical sleeve surface 44 and an inner cylindrical wall or surface 48. The surface 48 is spaced radially inwardly from the inner cylindrical sleeve surface 42. As shown best in FIGS. 3, 4 and 5, the force measuring cell 41 also includes a distal surface or surface portion 49 and a plurality of proximal surface portions 50 and 51. As shown, the wall 48 extends between the surface portion 49 and the surface portions 50,51. The distal surface 49 is a generally annular surface extending radially inwardly from the inner cylindrical sleeve surface 42. Preferably, this surface 49 is a continuous annular surface which lies in a plane perpendicular to the longitudinal axis of the actuator. The surface 49 is a force receiving surface. When the load cell 10 is assembled within the actuator, as shown best in FIG. 2, the surface 49 is engaged by the proximal end 39 of the outer bearing race 15. Accordingly, with this structure, axial forces acting on the rotor 16 are transferred to the distal end 35 of the inner bearing race 14 via the shoulder 21, then transferred through the bearing 11 and then transferred from the proximal end 39 of the outer bearing race 15 to the distal surface 49 of the force measuring cell 41.

The plurality of proximal surface portions include three force transfer surfaces 50 and three force measuring surfaces 51 between the surfaces 50. As shown best in FIGS. 2, 3, 4 and 6, the force transfer surfaces 50 are axially raised above the surfaces 51 in a proximal direction. In the preferred embodiment, the surface portions 50 lie on a common plane and are annular surface segments which are equally sized and equally spaced from, and positioned relative to, one another. Preferably, this common plane is perpendicular to the axial center of the load cell 10 and the longitudinal axis of the actuator when assembled. Similarly, the surface portions 51 lie on a common plane and are annular surface segments which are equally sized and equally spaced from, and positioned relative to, one another. Preferably, this common plane is perpendicular to the axial center of the load cell 10 and thus the actuator. Each of the surface portions 50 includes a pair of opposite ends 52 adjacent to and extending to the corresponding ends of the corresponding surface portions 51.

Although the preferred embodiment shows three force transfer surface portions 50 and three force measuring surface portions 51 between them, more or less of such surface portions could be provided. However, the proximal end of the load cell 10 should preferably include at least one force transfer surface 50 and at least one force measurement surface 51 adjacent to the force transfer surface 50. The preferred embodiment shows the size of the surface portions 50 to be equal to one another, the size of the surface portions 51 to be equal to one another and their respective positions and arrangement to be symmetrical. While this is a preferred construction, benefits of the invention can still be achieved with structures in which the surface portions 50 and the surface portions 51 are not equally sized and in which such surface portions 50 and 51 are not arranged symmetrically, either individually or in combination.

The force measuring cell 41 also includes a plurality of elongated flexing slots 55 corresponding to and associated with the plurality of force transmitting surface portions 50. These flexing slots define one or more flexing webs or strain measurement areas 61. As shown, each of these slots 55 extends radially through the wall of the cell 41 and between the distal surface 49 and its corresponding surface portion 50. Each of the slots 55 further extends circumferentially around the cell 41 for a distance greater than the circumferential length of its corresponding surface portion 50. With this structure and relationship, an end 56 of each slot extends past an end 52 of its corresponding surface portion 50. The wall portion of the cell 41 between the surface portion end 52 and its associated slot end 56 forms a flexing web or force or stress measurement area 61 (FIG. 8). More specifically, this web 61 is positioned between the slot 55 and a portion 59 of the surface 51 adjacent to the end 52.

In the preferred embodiment, each of the slots 55 extends radially through the wall of the cell portion 41 and is substantially of equal width in an axial direction throughout a substantial portion of its length. Further, the ends 56 of each slot are rounded and enlarged toward the surface portion 51 as shown by reference character 58. This rounded and enlarged end has the effect of directing the location of the strain created in the flexing web 61 in a desired direction, thereby facilitating measurement of the force acting on the bearing, and thus on the cell 41.

With continuing reference to FIGS. 3, 4 and 5, and more specific reference to FIG. 8, the area of each surface portion 51 between an end 52 of an adjacent surface portion 50 and the end 56 of its corresponding slot 55 defines a force measuring surface portion 59, with the flexing web 61 positioned between such surface portion 59 and its associated slot 55. Although the preferred embodiment shows three surface portions 50, three surface portions 51 and six surface portions 59 and flexing webs 61, at least one of the surface portions 59 is provided with a strain gauge 60. The strain gauge 60 functions to measure the strain in the web portion 61 of the cell 41 which is caused by the applied force “F”. The signal from this strain gauge 60 can in turn, through signal amplification, comparison and calibration techniques known in the art, be used to determine the level of the load or force “F” (FIG. 8) transferred from the outer bearing race 15 to the surface 49 and resisted by the surface 29 of the housing 12. Specifically, when a force “F” is exerted via the bearing race 15 on the surface 49, the web portion 61 will flex. The amount which this web 61 flexes will be proportional to the level of the force “F”.

The strain gauge 60 is a strain gauge of the type known in the art to measure strains on a member which is being flexed. In the preferred embodiment, the strain gauge 60 is a conventional strain gauge manufactured by Vishay Micromeasurement and includes a pair of spaced gauge elements 64 and 65 and a plurality of solder paths 66 for providing and receiving electrical signals in a manner known in the art. During operation, and by measuring differences in electrical resistance, one of the elements 64 and 65 will measure tensile forces and the other will measure compressive forces in the flexing web 61. The results of these measurements are then compared in a conventional manner through a Wheatstone bridge or other means and the force “F” is calculated through calibration techniques known in the art. A disc shaped electronic jumper or cable board 37 (FIG. 1) and a circuit board 43 (FIG. 1) comprising the amplification electronics are provided to house the electronics related to the strain gauge 60.

Preferably, the number, size and position of the surface portions 50, the number, size and position of the surface portions 51 and the number, size and position of the slots 55 should be such as to provide a substantially symmetrical structure. Such a structure minimizes, if not eliminates, stress concentrations which might exist in a non-symmetrical structure. In a symmetrical structure where stress variations are minimized, only one, or at least one, strain gauge 60 is needed. In the preferred embodiment, however, two strain gauges are used and are positioned approximately diametrically opposite from one another as shown in FIG. 3. With the two strain gauges 60 of the preferred embodiment, the electrical resistance of the gauge elements measuring tensile forces are combined, the electrical resistance of the gauge elements measuring compressive forces are combined and the two combined forces are then compared, thus further minimizing inaccuracies resulting from variations in stress distribution.

In the preferred embodiment, as best shown in FIG. 1, the strain gauge electronics are comprised of the strain gauge connector or jumper board 37 and the signal conditioning board 43 which functions primarily to provide an excitation voltage to the strain gauges and to amplify or otherwise condition the strain gauge signal. These boards 37 and 43, and thus the entire strain gauge electronics, are fully integrated within the actuator itself. As described below, this results in significant operational advantages.

Specifically, the generally annular connector board 37 is positioned near the proximal end of the load cell 10 and is secured to a portion of the inner cylindrical wall 48 of the cell portion 41 by a silicon based adhesive. In this position, extremely fine gauge jumper wires are used to electronically mount and connect the strain gauge pads 66 (FIG. 3) to the board 37. These jumper wires are very fragile and if extended for long lengths, vibration within the device can subject the wires to fatigue as well as the potential of pulling the strain gauges from the web to which they are bonded. By positioning the connection board 37 in close proximity to the strain gauges themselves, very short jumper wires can be used to connect with the strain gauge pads. This in turn facilitates the use of more robust through holes and heavier gauge connections from the board 37 to the board 43. In the preferred embodiment, connections between the board 37 and the board 43 are provided through holes 47 (FIG. 1) in the housing 12.

Significant advantages in accordance with the present invention are also achieved by integrating the signal conditioning electronics of the circuit board 43 within the actuator itself. A principal reason is that load cells, such as the load cell in accordance with the preferred embodiment, produce a very low level signal. If this low level signal needs to be transmitted out of the actuator through long cables on the order of up to fifteen feet or more to signal conditioning electronics on a robot, noise or other interference will likely be introduced, thereby quickly reducing the signal-to-noise ratio. By integrating the signal conditioning electronics onboard the actuator, noise or other interference becomes less significant with respect to the usable signal. The output from the board 43 on the actuator can be an analog or digital signal, depending on the controller available to utilize the signal. Further, depending upon the signal conditioning within the actuator on the board 43, the user has a signal that in many cases does not need further conditioning.

While the preferred embodiment shows the load cell and strain gauges positioned between the bearing and the bearing housing, the advantages of integrating the strain gauge electronics within the actuator itself can be achieved regardless of the position of the load cell. For example, the load cell could be incorporated within the bearing itself rather than between the bearing and housing. The load cell must, however, preferably be capable of measuring axial forces on the bearing.

The present invention is directed to a load cell for preferred use to measure or monitor the axial force exerted by a linear actuator. The invention is also directed to an actuator or bearing assembly incorporating such a load cell and an actuator in which the strain gauge electronics are integrated within the actuator itself. In such an actuator, axial force applied to a work piece is transmitted through the rotor or other actuator component to a rotation bearing. In the preferred embodiment, this force is transmitted from the rotor or other component to the inner race of the bearing and then transmitted through the bearing to the outer race and from the outer race of the bearing to a force measuring cell positioned between the bearing and the bearing housing. In the preferred embodiment, this force measuring cell includes a force receiving surface in engagement with the bearing, a force transmission surface in engagement with the bearing housing and a flexing web portion or other strain measuring area between the force receiving and force transmitting surfaces. With this structure, when a force is applied by the actuator to the distal end of the inner bearing race, the web flexes in proportion to the level of the force exerted by the actuator. The level of the force is determined by use of a conventional strain gauge applied to a surface of the flexing web or other strain measuring area. By measuring the tensile and compressive stresses in selected areas of the flexing web and by comparing the measurement results and utilizing calibration techniques known in the art, the level of the force “F” can be measured and/or monitored.

While the preferred embodiment shows the flexing web 61 created by the slot in combination with the surface portion 50, it is contemplated that such web 61 or other strain measurement area could be formed by other structural configurations. Further, it is contemplated that the strain gauge 60 or other strain measuring means may be provided at other locations in the area of the web 61 or other strain measuring areas.

Although the description of the preferred embodiment has been quite specific, it is contemplated that various modifications could be made without deviating from the spirit of the present invention. Accordingly, it is intended that the scope of the present invention be dictated by the appended claims rather than by the description of the preferred embodiment.

1. A linear actuator having a longitudinal axis, a distal end and a proximal end comprising:
a bearing housing;
a rotation support bearing having an inner race with a distal end and an outer race with a proximal end;
a rotation member in force transmitting engagement with said distal end of said inner race;
a load cell comprising a load measuring cell portion positioned axially between said bearing and said bearing housing and including a first surface portion in force receiving engagement with said proximal end of said outer race and a second surface portion in force transmitting engagement with said bearing housing.

2. The linear actuator of claim 1 wherein said load measuring cell portion includes a flexing web between said first and second surface portions.

3. The linear actuator of claim 2 wherein said flexing web is formed by a slot between said first and second surface portions and is positioned between said second surface portion and a portion of said slot.

4. The linear actuator of claim 2 wherein said load measuring cell portion includes a strain gauge in the area of said flexing web.

5. The linear actuator of claim 1 wherein said load measuring cell portion and said bearing housing include central openings along said longitudinal axis.

6. The linear actuator of claim 1 wherein said outer race includes an outer generally cylindrical surface, said bearing housing includes a generally cylindrical inner surface and said load cell includes a sleeve portion positioned between said generally inner cylindrical surface of said bearing housing and said generally outer cylindrical surface of said outer race.

7. The linear actuator of claim 1 wherein said load measuring cell portion includes a strain measuring area between said first and second surface portions.

8. The linear actuator of claim 7 wherein said load measuring cell portion includes a strain gauge in the area of said strain measuring area.

9. The linear actuator of claim 8 including strain gauge electronics integrated into a portion of the actuator.

10. The linear actuator of claim 9 wherein said strain gauge electronics includes a connector board electrically connected with said strain gauge and an amplification board electrically connected with said connector board, said connector board and said amplification electronics board integrated within said actuator.

11. A load cell comprising:
a generally cylindrical sleeve portion with a longitudinal axis defining an axial direction and having an inner cylindrical surface and
a load measuring cell portion having a central opening along said longitudinal axis and including;
a first surface portion extending inwardly from said inner cylindrical surface for receiving an axial force in the direction of said longitudinal axis,
a second surface portion axially spaced from said first surface portion,
a wall portion between said first and second surface portions,
a flexing web in said wall, and
a strain gauge operatively connected with said flexing web.

12. The load cell of claim 11 wherein said first and second surface portions are annular surface portions lying in respective first and second parallel planes.

13. The load cell of claim 12 wherein said first and second planes are perpendicular to said longitudinal axis.

14. The load cell of claim 12 including a plurality of said second surface portions, each of said plurality of second surface portions being circumferentially spaced from one another.

15. The load cell of claim 14 wherein said plurality of said second surface portions are equally sized and are positioned symmetrically with respect to one another.

16. The load cell of claim 11 wherein said wall portion includes a slot between said first and second surface portions and said flexing web is positioned between said second surface portion and a portion of said slot.

17. A bearing and load cell assembly comprising:
a bearing housing having a generally cylindrical inner surface and an inner end surface extending inwardly from said inner cylindrical surface;
a rotation bearing positioned within said bearing housing, said bearing having an inner race and an outer race, said outer race having an outer generally cylindrical surface; and
a load cell positioned between said bearing and said bearing housing, said load cell having;
a sleeve portion positioned between said inner cylindrical surface of said bearing housing and said outer cylindrical surface of said outer race and
a load measuring cell portion joined with and extending radially inwardly from said sleeve portion, said load measuring cell portion including a first surface portion in force receiving engagement with said outer race, a second surface in force transmitting engagement with said end surface of said bearing housing, a flexing web between said first and second surface portions and a strain gauge operatively connected to a portion of said flexing web.

18. The assembly of claim 17 wherein said load measuring cell portion includes a wall portion between said first and second surface portion and an elongated slot in said wall portion, said flexing web being positioned between said second surface portion and a portion of said slot.

19. The assembly of claim 18 including a plurality of said second surface portions.

20. The assembly of claim 19 wherein said plurality of said second surface portions are equally sized and are positioned symmetrically with respect to one another.

21. An actuator comprising:
an axial force application member;
a bearing assembly including a bearing housing and a bearing mounted within the bearing housing, said bearing operatively engaged with said force application member;
a load cell operatively connected with said bearing to measure an axial load within said bearing, said load cell including a strain gauge and strain gauge electronics integrated within the actuator.

22. The actuator of claim 21 wherein said strain gauge electronics includes a strain gauge connector board and a signal conditioning board.

23. The actuator of claim 21 wherein said load cell is positioned between a portion of said bearing and a portion of said bearing housing.
